(19) United States
(12) Patent Application Publication
(10) Pub. No.: US 2015/0019432 A1
(43) Pub. Date: Jan. 15, 2015

(54) MOBILE PAYMENTS USING PROXIMITY-BASED PEER-TO-PEER COMMUNICATION AND AN INTENT-TO-PAY GESTURE

(71) Applicant: QUALCOMM Incorporated, San Diego, CA (US)

(72) Inventor: Gregory BURNS, Seattle, WA (US)

(21) Appl. No.: 14/327,322

(22) Filed: Jul. 9, 2014

Related U.S. Application Data
(60) Provisional application No. 61/845,826, filed on Jul. 12, 2013.

(51) Int. Cl. G06Q 20/32; G06Q 20/40

(52) U.S. Cl. CPC G06Q 20/3278; G06Q 20/40
USPC 705/44

(57) ABSTRACT

The disclosure generally relates to mobile payments using proximity-based peer-to-peer (P2P) communication and an intent-to-pay gesture. In particular, a mobile device may detect a distinctive intent-to-pay gesture from one or more signals generated with one or more sensors on the mobile device. For example, the signals may indicate that the mobile device was gestured against a passive target that may resonate to indicate that the intent-to-pay gesture was made. The mobile device may then receive transaction details over a proximal P2P connection in response to detecting the intent-to-pay gesture and send a message over the proximal P2P connection to complete the mobile payment in response to receiving an input confirming the transaction details. Furthermore, the passive target may be constructed to produce a distinct resonant response that can be used to identify the passive target (e.g., using a microphone on the mobile device).

### CROSS-REFERENCE TO RELATED APPLICATIONS

The present application for patent claims the benefit of Provisional Patent Application No. 61/845,826 entitled “MOBILE PAYMENTS USING PROXIMITY-BASED PEER-TO-PEER COMMUNICATION AND AN INTENT-TO-PAY GESTURE,” filed on Jul. 12, 2013, which is assigned to the assignee hereof and hereby expressly incorporated herein by reference in its entirety.

### TECHNICAL FIELD

Various embodiments described herein generally relate to mobile payments using proximity-based peer-to-peer communication and an intent-to-pay gesture.

### BACKGROUND

Mobile payment is one of the main use cases for near-field communication (NFC), which refers to various standards that smartphones and similar devices may use to establish communication with one another through touching the devices together or bringing the devices into close proximity. In general, NFC operates over very short distances, usually no more than a few centimeters. As such, in order to perform a financial transaction or mobile payment, a user must bring an NFC-equipped mobile device close to an NFC-equipped point-of-sale terminal One benefit that may be offered from requiring close physical proximity is that intention to transact because the user must almost touch the mobile device to the point-of-sale device and the proximity enables the transacting devices to exchange information in order to complete the transaction. However, NFC suffers from various disadvantages and drawbacks, as numerous analysts are starting to observe, including that NFC has to be virtually ubiquitous in order to gain traction with consumers.

As such, the value that NFC brings to consumers tends to be very limited in the absence of widespread deployment of NFC point-of-sale terminals in grocery stores, gas stations, parking garages, coffee shops, fast-food outlets, public transit facilities, and other places where consumers tend to engage in financial transactions. Given that just about all of these establishments currently accept credit cards and many do not require a signature for low value transactions, it isn't clear how NFC can reach such ubiquity, particularly considering that owners of these establishments will likely bear the cost to upgrade point-of-sale terminals with NFC hardware in order to serve a relatively small section of customers that carry NFC-equipped mobile devices. On the other hand, many existing retail establishments already have Internet connectivity, and in many cases wireless Internet connectivity, meaning that they host a Wi-Fi access point. Similarly, Wi-Fi has already become nearly ubiquitous in mobile handsets, whereby Wi-Fi would clearly be a better choice for mobile payment transactions because widespread deployment of new hardware would not be required. Nonetheless, systems that support mobile payments over Wi-Fi must address certain problems, including that Wi-Fi access points in retail and similar establishments are usually secure and intent-to-transact can be difficult to capture given the comparatively long range of Wi-Fi.

### SUMMARY

The following presents a simplified summary relating to one or more aspects and/or embodiments associated with the mechanisms disclosed herein to support mobile payments using proximity-based peer-to-peer (P2P) communication and an intent-to-pay gesture. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein to support mobile payments using proximity-based P2P communication and an intent-to-pay gesture in a simplified form to precede the detailed description presented below.

According to one exemplary aspect, the mobile payment mechanisms disclosed herein may generally combine a proximity-based P2P network technology that provides connectivity between a payment application running on a mobile device and a point-of-sale (POS) terminal with an intent-to-pay indication based solely on input from existing sensors in the mobile device. In general, the mobile device and the POS terminal may have respective network interfaces and that the mobile device and the POS terminal employ to communicate over Wi-Fi, Bluetooth, Wi-Fi Direct, or another suitable short-range wireless technology rather than near-field communication (NFC). For example, in one embodiment, the mobile device and the POS terminal may each run respective bus daemons that communicate with one another over a distributed bus formed between the mobile device and the POS terminal in an ad hoc based on proximal discovery. As such, the payment application running on the mobile device may directly communicate with the local bus daemon and a payment application running on the POS terminal may similarly communicate directly with the local bus daemon, wherein the local bus daemons on the mobile device and the POS terminal may manage namespaces and message routing to enable P2P communication over the distributed bus. In one embodiment, the local bus daemons on the mobile device and the POS terminal may then form the distributed bus and connect to one another in response to discovering that the other exists when the mobile device and the POS terminal are proximally located.

According to another exemplary aspect, the proximity-based P2P network technology may be used to provide a mobile payment service in which the mobile device may be equipped with a three-dimensional accelerometer, gyroscope, or other suitable motion sensor that can detect movement associated with the mobile device with a high degree of accuracy. As such, in one embodiment, the payment application running on the mobile device may unambiguously detect an intent-to-pay motion that the motion sensor detects in response to a user making an intent-to-pay gesture with the mobile device against a suitably constructed passive target installed at the point-of-sale. For example, in one embodiment, the passive target may display instructions or be printed with instructions such as “gesture device here to pay” and have a resilient construction to ensure the mobile device will not be damaged when the user gestures the mobile device against the passive target. Alternatively (or additionally), the passive target 630 may be printed with a quick response (QR) code or have other suitable physical features that can be recognized or otherwise detected using the mobile device. For example, in one embodiment, the payment application may detect sufficient proximity to the passive target to determine an intent-to-transact in response to a camera on the mobile device capturing the QR code and determining proximity based on a size that the captured QR code has in the camera frame. In another example, the intent-to-transact may be inferred based on the point-of-sale terminal being the focal point of the camera, which may indicate proximity between the mobile device and the point-of-sale terminal. In any case, the passive target may generally not have communication capabilities and may not require any connectivity, in that the passive target may instead be used to determine sufficient proximity that may indicate an intent-to-transact (e.g., customer presence near a cash register).

According to another exemplary aspect, the payment application running on the mobile device may detect the distinctive motion indicating that the mobile device contacted the passive target and detect that the user has indicated an intent-to-transact. Alternatively (or additionally), the intent-to-pay gesture may be independent from the passive target, in that any suitable distinctive motion of the mobile device that can be detected with the motion sensor and used to capture intent-to-transact may be defined and used as the intent-to-pay. Accordingly, in response to the payment application detecting the intent-to-pay gesture, transaction details and a confirmation button may be displayed on a user interface. The user may then review the displayed transaction details and select the confirmation button to approve the mobile payment, which may cause the payment application to transmit a suitable message to the payment application on the POS terminal over the distributed bus. Alternatively, in response to the user selecting an option to not approve the mobile payment the message transmitted to the POS terminal may terminate or otherwise discard the transaction. Furthermore, in one embodiment, the POS terminal may send an alert to the mobile device over the distributed bus to inform the user that the transaction is ready to be conducted and inform the customer to make the intent-to-pay gesture to conduct the transaction.

According to another exemplary aspect, the passive target may have physical characteristics that may further refine the intent-to-transact detection avoid false positives. For example, the passive target may be designed to resonate or have another feedback mechanism that can provide tactile feedback such that the bounce that results from making the intent-to-pay gesture against the passive target results in a distinct motion that can be unambiguously detected. Furthermore, in one embodiment, the passive target may be constructed as a molded plastic box having an inner void that provides a resonant cavity feedback mechanism. In this respect, a microphone on the mobile device may be briefly activated after the payment application detects the distinctive intent-to-pay gesture in order to detect resonance information that the resonant cavity feedback mechanism produces when the mobile device has been gestured against the passive target. Further still, the passive target may be constructed to have a distinct resonant response that can be analyzed to identify the passive target. For example, multiple passive targets having respective feedback mechanisms that produce different resonant responses may be installed at the POS such that the payment application can determine the passive target against which the mobile device was gestured based on the resonant response that the microphone detects.

According to another exemplary aspect, relative to NFC-based solutions, the mobile payment mechanisms described herein in which proximity-based P2P communication and a passive target may support mobile payments may advantageously leverage infrastructure that already exists in many retails outlets and existing mobile devices and leverage Wi-Fi, Bluetooth, Wi-Fi Direct, and other widespread wireless technologies that can easily support P2P communication. Furthermore, the passive target may manufactured inexpensively and easily installed at the POS because the passive target may not have any radios or other communication interfaces and therefore do not require any connectivity, and moreover, the distinctive intent-to-pay gesture used to make the mobile payments may be simple to explain and easily understood to consumers, possibly more so than the swipe-to-pay gesture used in NFC-based solutions because the passive target may provide tactile and/or resonant feedback and the payment application may provide visual feedback via the user interface.

According to another exemplary aspect, a method for making a mobile payment may comprise detecting an intent-to-pay gesture on a mobile device (e.g., a distinctive motion that indicates intent-to-transact) based on one or more signals that one or more sensors on the mobile device generate, receiving transaction details at the mobile device over a proximal P2P connection (e.g., a Wi-Fi, Bluetooth, Wi-Fi Direct, or other suitable proximal P2P connection) in response to detecting the intent-to-pay gesture, and sending a message over the proximal P2P connection to complete the mobile payment in response to the mobile device receiving an input that confirms the transaction details. For example, in one embodiment, the mobile device may detect the intent-to-pay gesture in response to the one or more sensors generating signals indicating that the mobile device was gestured against a passive target that does not have a communications interface, wherein the passive target may be constructed to resonate when the intent-to-pay gesture is made against the passive target such that the one or more signals indicate the intent-to-pay gesture. Furthermore, in one embodiment, the passive target may have a resonant cavity that produces a distinct resonant response that the mobile device can use to identify the passive target against which the mobile device was gestured. For example, in one embodiment, the mobile device may temporarily activate a microphone to capture the distinct resonant response in response to detecting the intent-to-pay gesture and use the captured resonant response to identify the passive target (e.g., at a point-of-sale having multiple such passive targets). Furthermore, in one embodiment, the mobile device may capture information printed on the passive target using a camera to confirm the intent-to-transact based on a proximity between the mobile device and a point-of-sale, which may be determined from a size that the printed information has within the camera frame, an object located at a focal point of the camera, or other suitable information obtained with the camera.

According to another exemplary aspect, a mobile device may comprise one or more sensors configured to generate one or more signals indicating that the mobile device was gestured against a passive target lacking a communication interface, one or more processors configured to detect an intent-to-pay gesture based on the one or more signals that the one or more sensors generated, and a network interface configured to receive transaction details over a proximal peer-to-peer connection in response to the intent-to-pay gesture and to send a message over the proximal peer-to-peer connection to complete a mobile payment in response to an input confirming the transaction details. Furthermore, in one embodiment, the one or more processors may be configured to identify the passive target against which the mobile device was gestured based on a distinct resonant response produced by the passive target. For example, in one embodiment, the mobile device may comprise a microphone configured to capture the distinct resonant response, wherein the one or more processors may temporarily activate the microphone to capture the distinct resonant response in response to detecting the intent-to-pay gesture. In another embodiment, the mobile device may comprise a camera configured to capture information printed on the passive target, wherein the one or more processors may confirm the intent-to-transact in response to the printed information having a size within the camera frame that indicates a predefined proximity between the mobile device and a point-of-sale. Alternatively (or additionally), the one or more processors may determine a focal point associated with the camera and confirm the intent-to-transact in response to the camera focal point corresponding to a point-of-sale located in proximity to the mobile device.

According to another exemplary aspect, an apparatus may comprise means for detecting an intent-to-pay gesture indicating that the apparatus was gestured against a passive target lacking a communication interface, means for receiving transaction details over a proximal peer-to-peer connection in response to the intent-to-pay gesture, and means for sending a message over the proximal peer-to-peer connection to complete a mobile payment in response to an input confirming the transaction details.

According to another exemplary aspect, a computer-readable storage medium may have computer-executable instructions recorded thereon, wherein executing the computer-executable instructions on a mobile device may cause the mobile device to detect an intent-to-pay gesture indicating that the mobile device was gestured against a passive target lacking a communication interface based on one or more signals generated with one or more sensors on the mobile device, receive transaction details at the mobile device over a proximal peer-to-peer connection in response to detecting the intent-to-pay gesture, and send a message over the proximal peer-to-peer connection to complete a mobile payment in response to an input confirming the transaction details.

According to another exemplary aspect, a method for making a mobile payment may comprise detecting, on a mobile device, an intent-to-transact based on information captured using a camera on the mobile device, receiving transaction details at the mobile device over a proximal peer-to-peer connection in response to detecting the intent-to-transact, and sending a message over the proximal peer-to-peer connection to complete the mobile payment in response to an input confirming the transaction details. For example, in one embodiment, detecting the intent-to-transact may comprise capturing printed information located at a point-of-sale using the camera and detecting the intent-to-transact based on the printed information having a size within the camera frame indicating that the mobile device is located within a predefined proximity to the point-of-sale. Alternatively, in one embodiment, detecting the intent-to-transact may comprise determining a focal point associated with the camera and detecting the intent-to-transact in response to determining that the camera focal point corresponds to a point-of-sale.

According to another exemplary aspect, a mobile device may comprise a camera, one or more processors configured to detect an intent-to-transact based on information captured using the camera, and a network interface configured to receive transaction details over a proximal peer-to-peer connection in response to the one or more processors detecting the intent-to-transact and to send a message over the proximal peer-to-peer connection to complete a mobile payment in response to an input confirming the transaction details.

According to another exemplary aspect, an apparatus may comprise means for detecting an intent-to-transact based on information captured using a camera, means for receiving transaction details over a proximal peer-to-peer connection in response to detecting the intent-to-transact, and means for sending a message over the proximal peer-to-peer connection to complete a mobile payment in response to an input confirming the transaction details.

According to another exemplary aspect, a computer-readable storage medium may have computer-executable instructions recorded thereon, wherein executing the computer-executable instructions on a mobile device may cause the mobile device to detect an intent-to-transact based on information captured using a camera, receive transaction details over a proximal peer-to-peer connection in response to detecting the intent-to-transact, and send a message over the proximal peer-to-peer connection to complete a mobile payment in response to an input confirming the transaction details.

Other objects and advantages associated with the various aspects and embodiments disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system, in accordance with one aspect of the disclosure.

FIG. 2 illustrates exemplary user equipments (UEs), in accordance with one aspect of the disclosure.

FIG. 3 illustrates a communication device that includes logic configured to perform functionality, in accordance one aspect of the disclosure.

FIG. 4 illustrates a server, in accordance with one aspect of the disclosure.

FIG. 4 illustrates a communication device that includes logic configured to perform functionality in accordance with one aspect of the disclosure.

FIG. 5 illustrates a wireless communication network that may support discoverable peer-to-peer (P2P) services, according to one aspect of the disclosure.

FIG. 6 illustrates an exemplary environment in which discoverable P2P services may be used to establish a proximity-based distributed bus over which various devices may communicate, according to one aspect of the disclosure.

FIG. 7 illustrates an exemplary message sequence in which discoverable P2P services may be used to establish a proximity-based distributed bus over which various devices may communicate, according to one aspect of the disclosure.

FIG. 8A illustrates an exemplary proximity-based distributed bus that may be formed between two host devices, while FIG. 8B illustrates an exemplary proximity-based distributed bus in which one or more embedded devices may connect to a host device to connect to the proximity-based distributed bus, according to one aspect of the disclosure.

FIGS. 9A-B illustrate exemplary environments in which proximity-based P2P communication and an intent-to-pay gesture may be used to support mobile payments, in accordance with one aspect of the disclosure.

FIG. 10 illustrates an exemplary method that a mobile device may perform to make mobile payments using proximity-based P2P communication and intent-to-pay gesture, in accordance with one aspect of the disclosure.

FIG. 11 illustrates an exemplary method that a point-of-sale terminal device may perform to process mobile payments using proximity-based P2P communication and intent-to-pay gesture, in accordance with one aspect of the disclosure.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

The terminology used herein is intended to describe particular embodiments only and not to limit any embodiments disclosed herein. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal,” an “AT,” a “wireless device,” a “subscriber device,” a “subscriber terminal,” a “subscriber station,” a “user terminal” (or UT), a “mobile terminal,” a “mobile station,” a “mobile device,” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, Wi-Fi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein, the term traffic channel (TCH) can refer to either an uplink/reverse or a downlink/forward traffic channel.

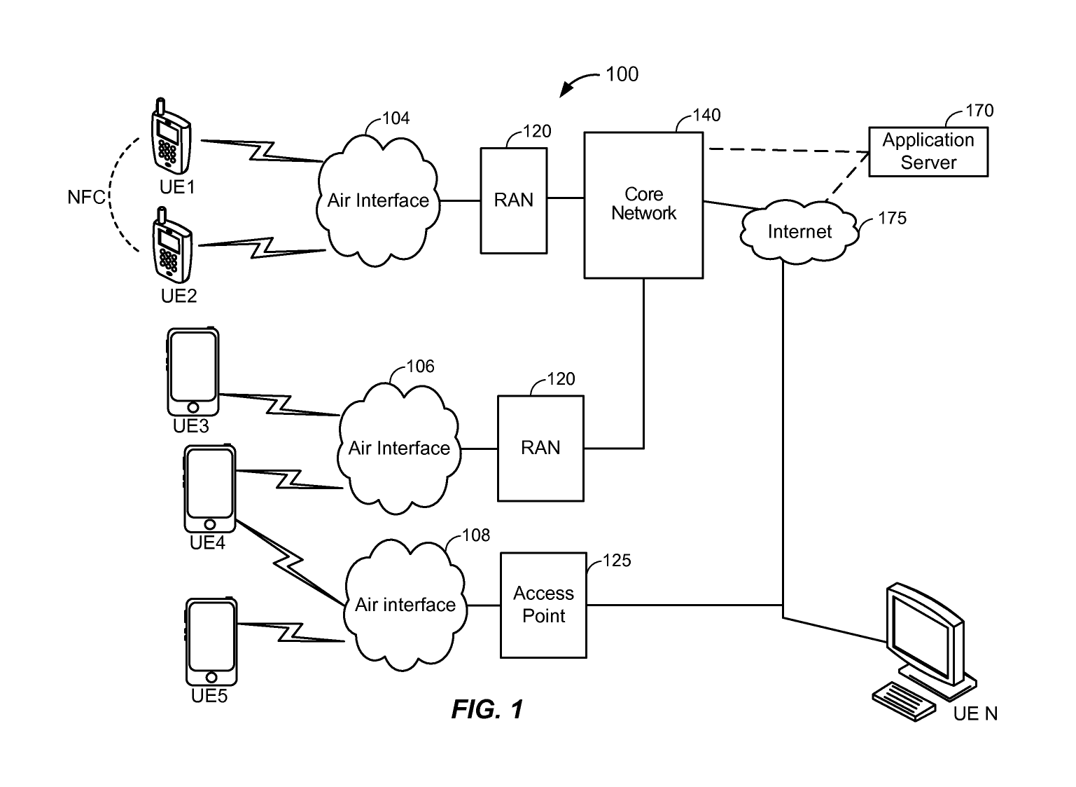

FIG. 1 illustrates a high-level system architecture of a wireless communications system 100 in accordance with one aspect of the disclosure. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EV-DO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of Wi-Fi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., a Wi-Fi router with wired and/or wireless connectivity may correspond to the access point 125).

Referring still to FIG. 1, certain UEs may be configured to communicate using a near-field communication (NFC) interface. For example, UE 1 may have an NFC interface in which input power may be provided to a transmitter that uses the input power to generate a magnetic field for providing energy transfer and UE 2 may likewise have an NFC interface in which a receiver may couple to the magnetic field that UE 1 to generate an output power that may be stored or consumed therein. Accordingly, when the resonant frequency of the receiver at UE 2 matches the resonant frequency of the transmitter at UE 1, transmission losses between the transmitter and the receiver are minimal when the receiver is located in the “near-field” of the magnetic field and energy transfer may thereby occur between UE 1 and UE 2 in order to enable communication therebetween. Furthermore, those skilled in the art will appreciate that the NFC interface in UE 1 may include a similar receiver and the NFC interface in UE 2 may include a similar transmitter in order to facilitate NFC in the opposite direction.

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175, and/or to provide content (e.g., web page downloads) to the UEs.

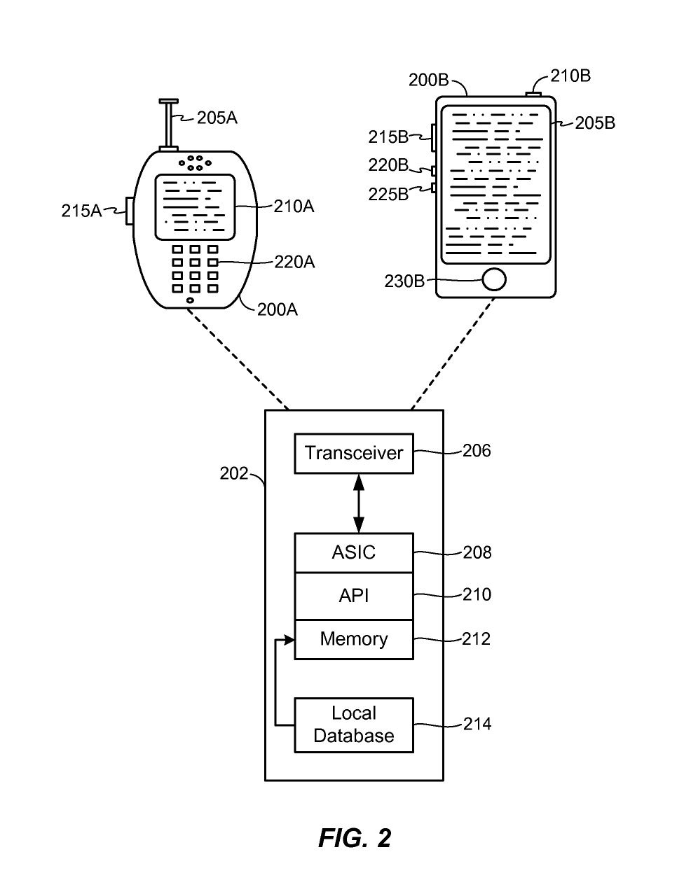

FIG. 2 illustrates examples of UEs in accordance with one aspect of the disclosure. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), at least one front-panel button 230B (e.g., a Home button, etc.), among other components, as is known in the art. While not shown explicitly as part of UE 200B, the UE 200B can include one or more external antennas and/or one or more integrated antennas that are built into the external casing of UE 200B, including but not limited to Wi-Fi antennas, cellular antennas, satellite position system (SPS) antennas (e.g., global positioning system (GPS) antennas), and so on.

While internal components of UEs such as the UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., application server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in memory 212, as well as other data. The local database 214 is typically a flash memory cell, but can be any secondary storage device as known in the art, such as magnetic media, EEPROM, optical media, tape, soft or hard disk, or the like.

Accordingly, one embodiment can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative and the features of the UEs 200A and 200B in FIG. 2 are not limited to the illustrated features or arrangement.

The wireless communication between the UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments disclosed herein and are merely to aid in the description of aspects of the disclosed embodiments.

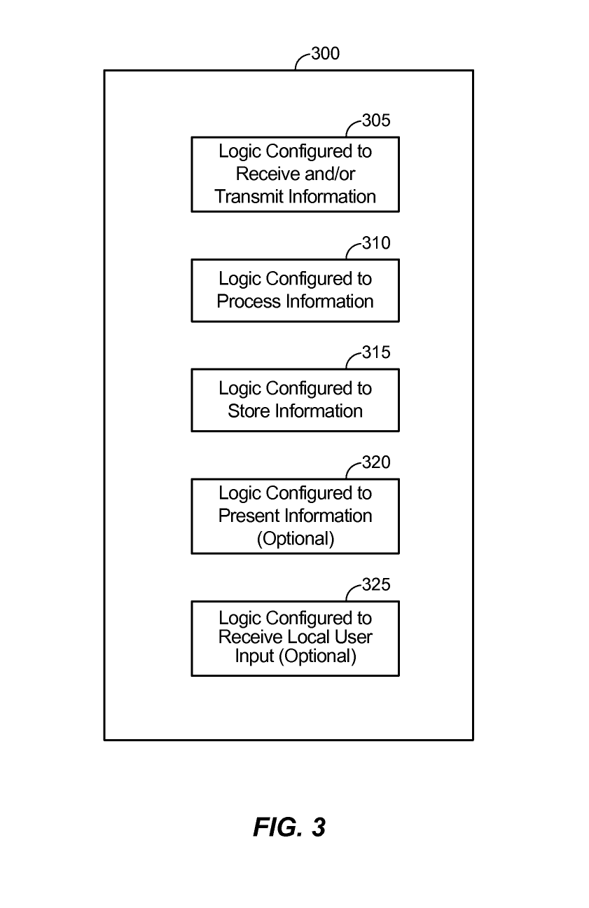

FIG. 3 illustrates a communication device 300 that includes logic configured to perform functionality. The communication device 300 can correspond to any of the above-noted communication devices, including but not limited to UEs 200A or 300B, any component of the RAN 120, any component of the core network 140, any components coupled with the core network 140 and/or the Internet 175 (e.g., the application server 170), and so on. Accordingly, the communication device 300 shown in FIG. 3 can correspond to any electronic device that is configured to communicate with (or facilitate communication with) one or more other entities over the wireless communications system 100 of FIG. 1.

Referring to FIG. 3, the communication device 300 includes logic configured to receive and/or transmit information 305. In an example, if the communication device 300 corresponds to a wireless communications device (e.g., UE 200A or 200B, AP 125, a BS, Node B or eNodeB in the RAN 120, etc.), the logic configured to receive and/or transmit information 305 can include a wireless communications interface (e.g., Bluetooth, Wi-Fi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the application server 170, etc.), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM memory, flash memory, ROM memory, EPROM memory, EEPROM memory, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to UE 200A or UE 200B as shown in FIG. 2, the logic configured to present information 320 can include the display 210A of UE 200A or the touchscreen display 205B of UE 200B. In a further example, the logic configured to present information 320 can be omitted for certain communication devices, such as network communication devices that do not have a local user (e.g., network switches or routers, remote servers such as the application server 170, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to UE 200A or UE 200B as shown in FIG. 2, the logic configured to receive local user input 325 can include the keypad 220A, any of the buttons 215A or 210B through 225B, the touchscreen display 205B, etc. In a further example, the logic configured to receive local user input 325 can be omitted for certain communication devices, such as network communication devices that do not have a local user (e.g., network switches or routers, remote servers, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

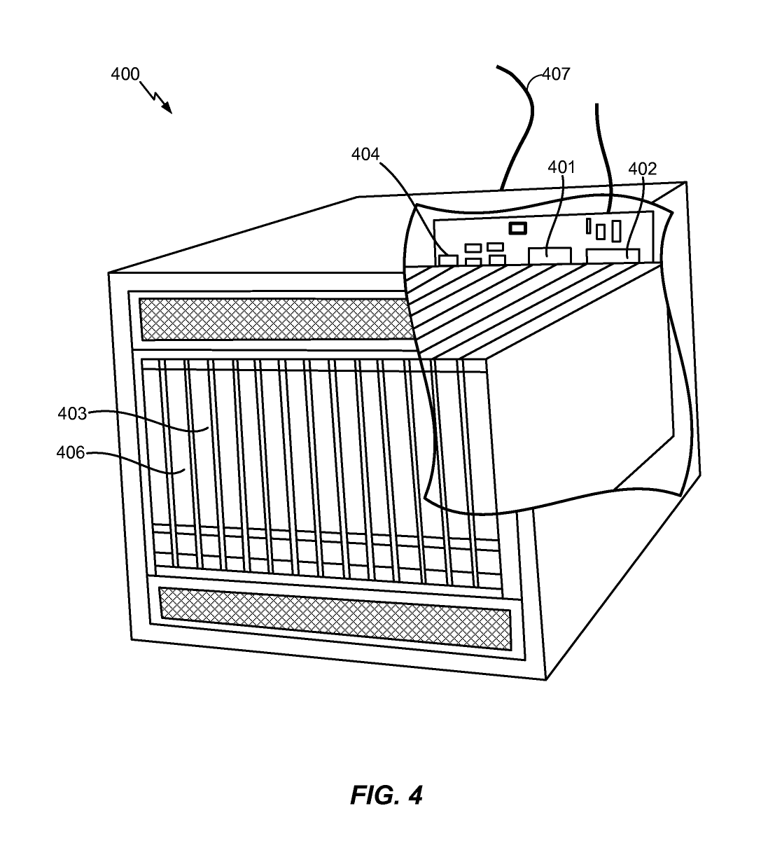

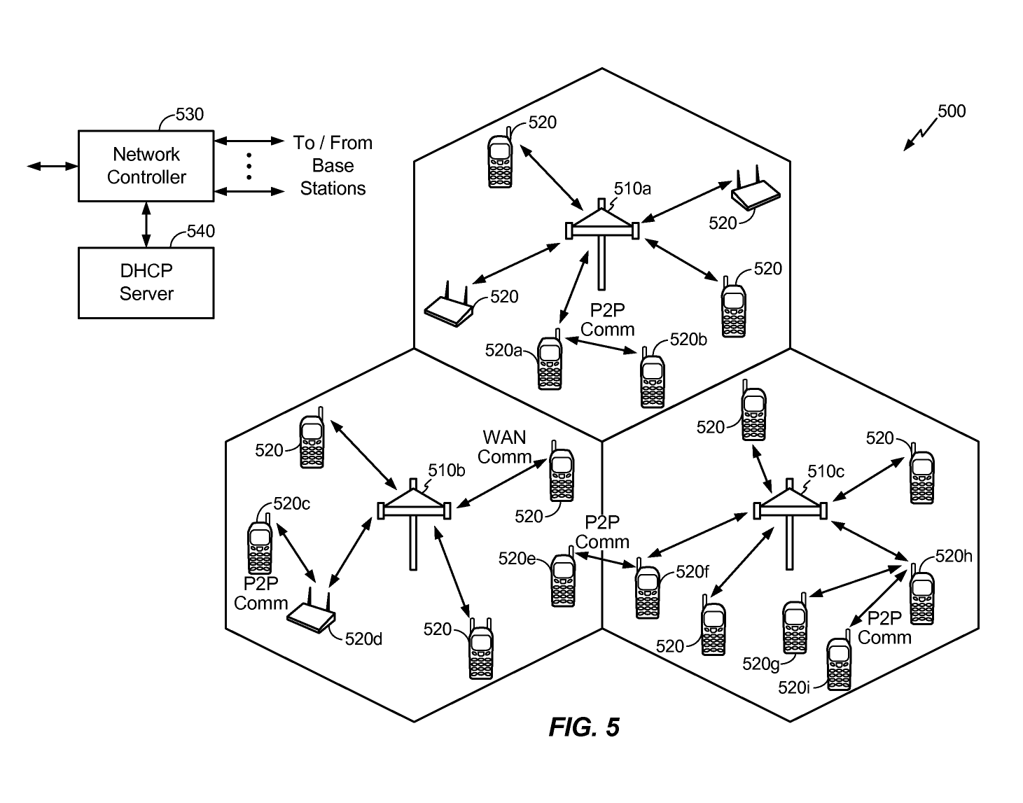

The various embodiments may be implemented on any of a variety of commercially available server devices, such as server 400 illustrated in FIG. 4. In an example, the server 400 may correspond to one example configuration of the application server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access ports 404 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to a UE implementation as in 205A or 205B as in FIG. 2.

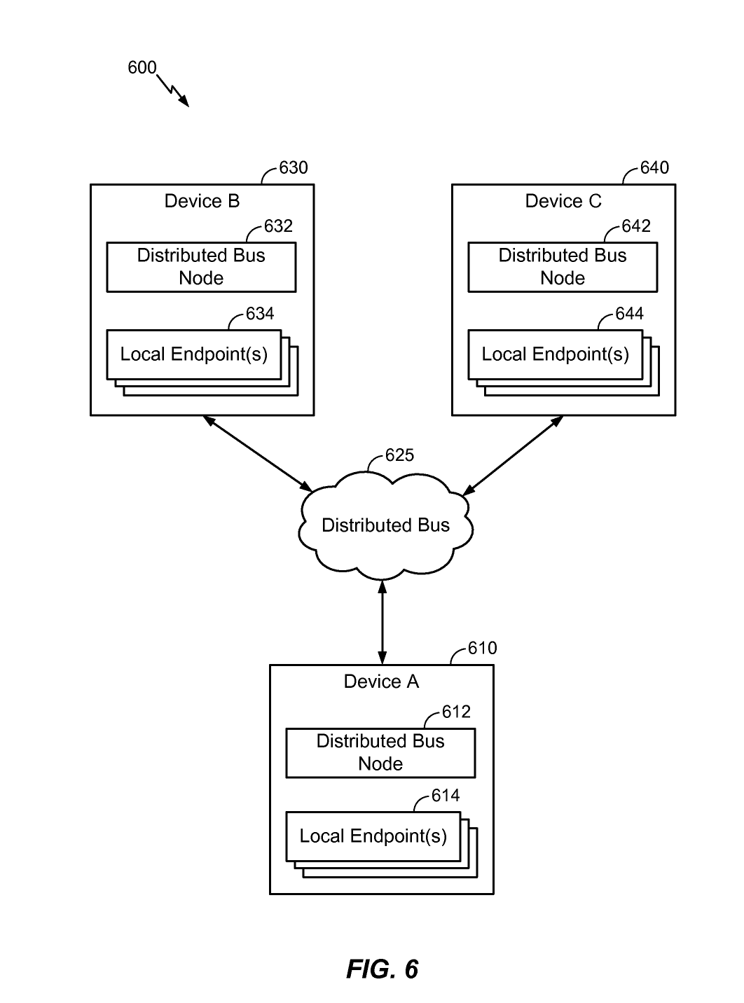

In general, user equipment (UE) such as telephones, tablet computers, laptop and desktop computers, certain vehicles, etc., can be configured to connect with each other either locally (e.g., Bluetooth, local Wi-Fi, etc.) or remotely (e.g., via cellular networks, through the Internet, etc.). Furthermore, certain UEs may also support proximity-based peer-to-peer (P2P) communication using certain wireless networking technologies (e.g., Wi-Fi, Bluetooth, Wi-Fi Direct, etc.) that enable devices to make a one-to-one connection or simultaneously connect to a group that includes several devices in order to directly communicate with one another. To that end, FIG. 5 illustrates an exemplary wireless communication network or WAN 500 supporting P2P communication, which may be a LTE network or another suitable WAN that includes various base stations 510 and other network entities. For simplicity, only three base stations 510a, 510b and 510c, one network controller 530, and one Dynamic Host Configuration Protocol (DHCP) server 540 are shown in FIG. 5. A base station 510 may be an entity that communicates with devices 520 and may also be referred to as a Node B, an evolved Node B (eNB), an access point, etc. Each base station 510 may provide communication coverage for a particular geographic area and may support communication for the devices 520 located within the coverage area. To improve network capacity, the overall coverage area of a base station 510 may be partitioned into multiple (e.g., three) smaller areas, wherein each smaller area may be served by a respective base station 510. In 3GPP, the term “cell” can refer to a coverage area of a base station 510 and/or a base station subsystem 510 serving this coverage area, depending on the context in which the term is used. In 3GPP2, the term “sector” or “cell-sector” can refer to a coverage area of a base station 510 and/or a base station subsystem 510 serving this coverage area. For clarity, the 3GPP concept of “cell” may be used in the description herein.

A base station 510 may provide communication coverage for a macro cell, a pico cell, a femto cell, and/or other cell types. A macro cell may cover a relatively large geographic area (e.g., several kilometers in radius) and may allow unrestricted access by devices 520 with service subscription. A pico cell may cover a relatively small geographic area and may allow unrestricted access by devices 520 with service subscription. A femto cell may cover a relatively small geographic area (e.g., a home) and may allow restricted access by devices 520 having association with the femto cell (e.g., devices 520 in a Closed Subscriber Group (CSG)). In the example shown in FIG. 5, wireless network 500 includes macro base stations 510a, 510b and 510c for macro cells. Wireless network 500 may also include pico base stations 510 for pico cells and/or home base stations 510 for femto cells (not shown in FIG. 5).

Network controller 530 may couple to a set of base stations 510 and may provide coordination and control for these base stations 510. Network controller 530 may be a single network entity or a collection of network entities that can communicate with the base stations via a backhaul. The base stations may also communicate with one another, e.g., directly or indirectly via wireless or wireline backhaul. DHCP server 540 may support P2P communication, as described below. DHCP server 540 may be part of wireless network 500, external to wireless network 500, run via Internet Connection Sharing (ICS), or any suitable combination thereof. DHCP server 540 may be a separate entity (e.g., as shown in FIG. 5) or may be part of a base station 510, network controller 530, or some other entity. In any case, DHCP server 540 may be reachable by devices 520 desiring to communicate peer-to-peer.

Devices 520 may be dispersed throughout wireless network 500, and each device 520 may be stationary or mobile. A device 520 may also be referred to as a node, user equipment (UE), a station, a mobile station, a terminal, an access terminal, a subscriber unit, etc. A device 520 may be a cellular phone, a personal digital assistant (PDA), a wireless modem, a wireless communication device, a handheld device, a laptop computer, a cordless phone, a wireless local loop (WLL) station, a smart phone, a netbook, a smartbook, a tablet, etc. A device 520 may communicate with base stations 510 in the wireless network 500 and may further communicate peer-to-peer with other devices 520. For example, as shown in FIG. 5, devices 520a and 520b may communicate peer-to-peer, devices 520c and 520d may communicate peer-to-peer, devices 520e and 520f may communicate peer-to-peer, and devices 520g, 520h, and 520i may communicate peer-to-peer, while remaining devices 520 may communicate with base stations 510. As further shown in FIG. 5, devices 520a, 520d, 520f, and 520h may also communicate with base stations 500, e.g., when not engaged in P2P communication or possibly concurrent with P2P communication.

In the description herein, WAN communication may refer to communication between a device 520 and a base station 510 in wireless network 500, e.g., for a call with a remote entity such as another device 520. A WAN device is a device 520 that is interested or engaged in WAN communication. P2P communication refers to direct communication between two or more devices 520, without going through any base station 510. A P2P device is a device 520 that is interested or engaged in P2P communication, e.g., a device 520 that has traffic data for another device 520 within proximity of the P2P device. Two devices may be considered to be within proximity of one another, for example, if each device 520 can detect the other device 520. In general, a device 520 may communicate with another device 520 either directly for P2P communication or via at least one base station 510 for WAN communication.

In one embodiment, direct communication between P2P devices 520 may be organized into P2P groups. More particularly, a P2P group generally refers to a group of two or more devices 520 interested or engaged in P2P communication and a P2P link refers to a communication link for a P2P group. Furthermore, in one embodiment, a P2P group may include one device 520 designated a P2P group owner (or a P2P server) and one or more devices 520 designated P2P clients that are served by the P2P group owner. The P2P group owner may perform certain management functions such as exchanging signaling with a WAN, coordinating data transmission between the P2P group owner and P2P clients, etc. For example, as shown in FIG. 5, a first P2P group includes devices 520a and 520b under the coverage of base station 510a, a second P2P group includes devices 520c and 520d under the coverage of base station 510b, a third P2P group includes devices 520e and 520f under the coverage of different base stations 510b and 510c, and a fourth P2P group includes devices 520g, 520h and 520i under the coverage of base station 510c. Devices 520a, 520d, 520f, and 520h may be P2P group owners for their respective P2P groups and devices 520b, 520c, 520e, 520g, and 520i may be P2P clients in their respective P2P groups. The other devices 520 in FIG. 5 may be engaged in WAN communication.

In one embodiment, P2P communication may occur only within a P2P group and may further occur only between the P2P group owner and the P2P clients associated therewith. For example, if two P2P clients within the same P2P group (e.g., devices 520g and 520i) desire to exchange information, one of the P2P clients may send the information to the P2P group owner (e.g., device 520h) and the P2P group owner may then relay transmissions to the other P2P client. In one embodiment, a particular device 520 may belong to multiple P2P groups and may behave as either a P2P group owner or a P2P client in each P2P group. Furthermore, in one embodiment, a particular P2P client may belong to only one P2P group or belong to multiple P2P group and communicate with P2P devices 520 in any of the multiple P2P groups at any particular moment. In general, communication may be facilitated via transmissions on the downlink and uplink. For WAN communication, the downlink (or forward link) refers to the communication link from base stations 510 to devices 520, and the uplink (or reverse link) refers to the communication link from devices 520 to base stations 510. For P2P communication, the P2P downlink refers to the communication link from P2P group owners to P2P clients and the P2P uplink refers to the communication link from P2P clients to P2P group owners. In certain embodiments, rather than using WAN technologies to communicate P2P, two or more devices may form smaller P2P groups and communicate P2P on a wireless local area network (WLAN) using technologies such as Wi-Fi, Bluetooth, or Wi-Fi Direct. For example, P2P communication using Wi-Fi, Bluetooth, Wi-Fi Direct, or other WLAN technologies may enable P2P communication between two or more mobile phones, game consoles, laptop computers, or other suitable communication entities.

Furthermore, as will be described in further detail herein, proximity-based P2P communication using WLAN technologies may be used to facilitate mobile payments at a point-of-sale (POS) and thereby address various drawbacks and disadvantages associated with existing mobile payment systems. For example, proximity-based P2P communication may offer certain advantages for devices 520 located close to each other, which may include improved efficiency because the pathloss between two devices 520 may be substantially smaller than the pathloss between either device 520 to its serving base station 510 and/or WLAN access point 510. Furthermore, the two devices 520 may directly communicate with each other wirelessly via a single transmission hop for P2P communication, whereas two hops are typically required to communicate over a WAN or through a WLAN access point 510 (e.g., a first hop for the uplink from one device 520 to its serving base station 510 or the WLAN access point 510 and a second hop for the downlink from the same or different base station 510 or access point 510 to the other device 520). P2P communication may therefore offer improved user capacity and improved network capacity by shifting some load over to P2P communication, and furthermore, may eliminate the need to have a central access point 510 because wireless devices within suitable range of each other can discover one another and communicate with one another directly. Furthermore, relative to existing mobile payment systems based on near-field communication (NFC), proximity-based P2P communication may advantageously leverage existing hardware capabilities and widespread Internet connectivity in many existing retail establishments rather than requiring retail establishments to deploy POS terminals equipped with NFC hardware or depending on consumers purchasing new mobile devices equipped with NFC hardware.

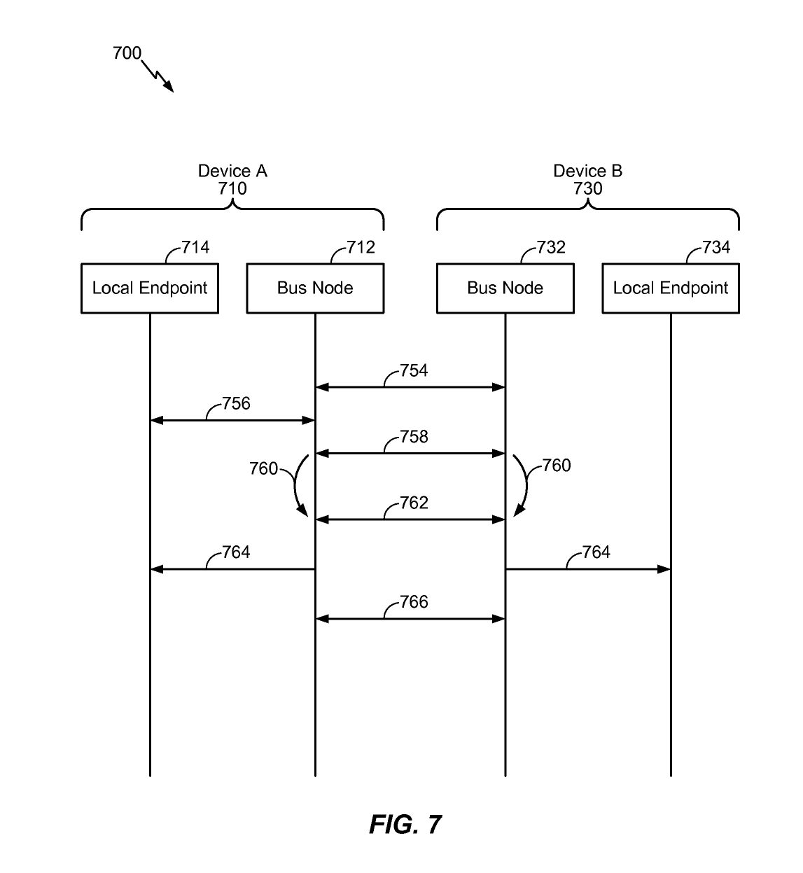

According to one aspect of the disclosure, FIG. 6 illustrates an exemplary environment 600 in which discoverable P2P services may be used to establish a proximity-based distributed bus over which various devices 610, 630, 640 may communicate. For example, in one embodiment, communications between applications and the like, on a single platform may be facilitated using an interprocess communication protocol (IPC) framework over the distributed bus 625, which may comprise a software bus used to enable application-to-application communications in a networked computing environment where applications register with the distributed bus 625 to offer services to other applications and other applications query the distributed bus 625 for information about registered applications. Such a protocol may provide asynchronous notifications and remote procedure calls (RPCs) in which signal messages (e.g., notifications) may be point-to-point or broadcast, method call messages (e.g., RPCs) may be synchronous or asynchronous, and the distributed bus 625 may handle message routing between the various devices 610, 630, 640 (e.g., via one or more “daemons” or other processes that provide attachments to the distributed bus 625).

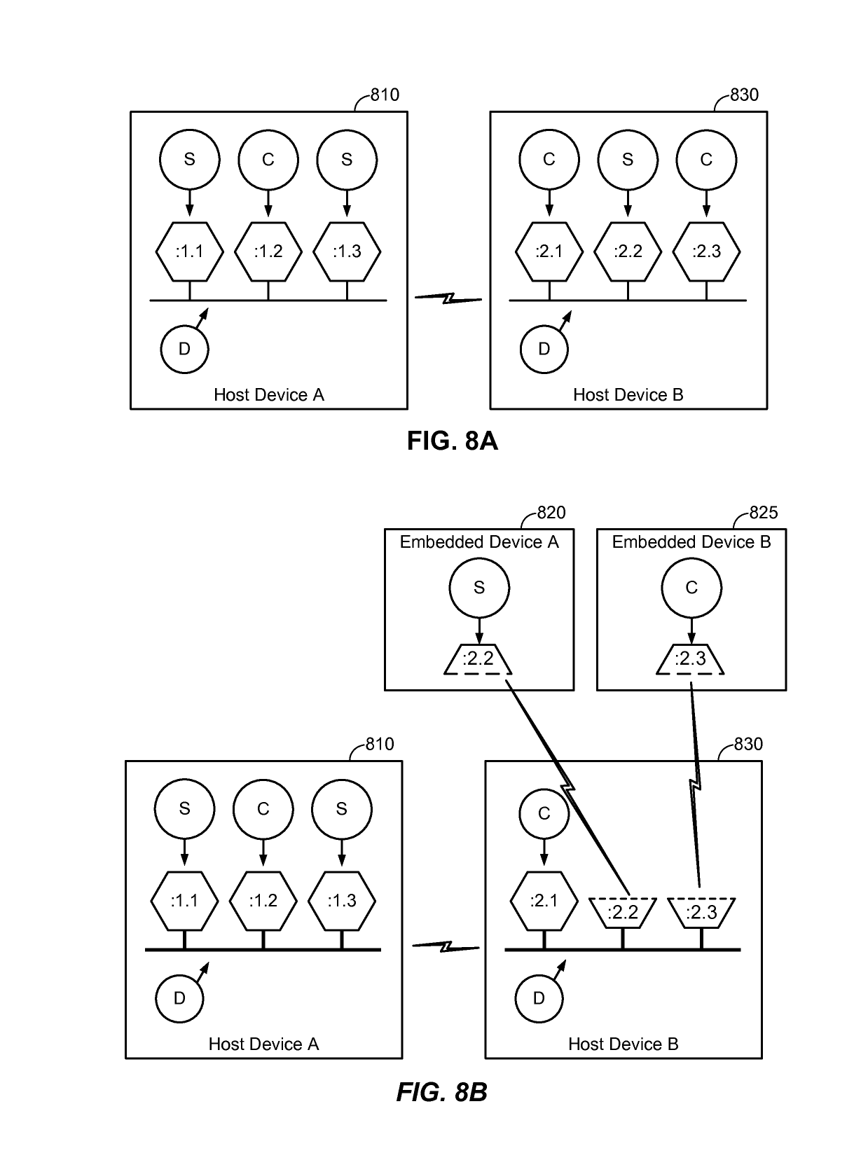

In one embodiment, the distributed bus 625 may be supported by a variety of transport protocols (e.g., Bluetooth, TCP/IP, Wi-Fi, CDMA, GPRS, UMTS, etc.). For example, according to one aspect, a first device 610 may include a distributed bus node 612 and one or more local endpoints 614, wherein the distributed bus node 612 may facilitate communications between local endpoints 614 associated with the first device 610 and local endpoints 634 and 644 associated with a second device 630 and a third device 640 through the distributed bus 625 (e.g., via distributed bus nodes 632 and 642 on the second device 630 and the third device 640, respectively). As will be described in further detail below with reference to FIG. 7, the distributed bus 625 may support symmetric multi-device network topologies and may provide a robust operation in the presence of device drops-outs. As such, the virtual distributed bus 625, which may generally be independent from any underlying transport protocol (e.g., Bluetooth, TCP/IP, Wi-Fi, etc.) may allow various security options, from unsecured (e.g., open) to secured (e.g., authenticated and encrypted), wherein the security options can be used while facilitating spontaneous connections with among the first device 610, the second device 630, and the third device 640 without intervention when the various devices 610, 630, 640, etc. come into range or proximity to each other.

According to one aspect of the disclosure, FIG. 7 illustrates an exemplary message sequence 700 in which discoverable P2P services may be used to establish a proximity-based distributed bus over which a first device (“Device A”) 710 and a second device (“Device B”) 730 may communicate. Generally, Device A 710 may request to communicate with Device B 730, wherein Device A 710 may a include local endpoint 714 (e.g., a local application, service, etc.), which may make a request to communicate in addition to a bus node 712 that may assist in facilitating such communications. Further, Device B 730 may include a local endpoint 734 with which the local endpoint 714 may be attempting to communicate in addition to a bus node 732 that may assist in facilitating communications between the local endpoint 714 on the Device A 710 and the local endpoint 734 on Device B 730.

In one embodiment, at 754, the bus nodes 712 and 732 may perform a suitable discovery mechanism. For example, mechanisms for discovering connections supported by Bluetooth, TCP/IP, UNIX, or the like may be used. At 756, the local endpoint 714 on Device A 710 may request to connect to an entity, service, endpoint, etc. available through bus node 712. In one embodiment, the request may include a request-and-response process between local endpoint 714 and bus node 712. At 758, a distributed message bus may be formed to connect bus node 712 to bus node 732 and thereby establish a P2P connection between Device A 710 and Device B 730. In one embodiment, communications to form the distributed bus between the bus nodes 712 and 732 may be facilitated using a suitable proximity-based P2P protocol (e.g., the AllJoyn™ software framework designed to enable interoperability among connected products and software applications from different manufacturers to dynamically create proximal networks and facilitate proximal P2P communication). Alternatively, in one embodiment, a server (not shown) may facilitate the connection between the bus nodes 712 and 732. Furthermore, in one embodiment, a suitable authentication mechanism may be used prior to forming the connection between bus nodes 712 and 732 (e.g., SASL authentication in which a client may send an authentication command to initiate an authentication conversation). Still further, at 758, bus nodes 712 and 732 may exchange information about other available endpoints (e.g., local endpoints 634 on Device C 630 in FIG. 6). In such embodiments, each local endpoint that a bus node maintains may be advertised to other bus nodes, wherein the advertisement may include unique endpoint names, transport types, connection parameters, or other suitable information.

In one embodiment, at 760, bus node 712 and bus node 732 may use the obtained information about the local endpoints 734 and 714, respectively, to create virtual endpoints that may represent the real obtained endpoints available through various bus nodes. In one embodiment, message routing on the bus node 712 may use real and virtual endpoints to deliver messages. Further, there may one local virtual endpoint for every endpoint that exists on remote devices (e.g., Device A 710). Still further, such virtual endpoints may multiplex and/or de-multiplex messages sent over the distributed bus (e.g., a connection between bus node 712 and bus node 732). In one aspect, virtual endpoints may receive messages from the local bus node 712 or 732, just like real endpoints, and may forward messages over the distributed bus. As such, the virtual endpoints may forward messages to the local bus nodes 712 and 732 from the endpoint multiplexed distributed bus connection. Furthermore, in one embodiment, virtual endpoints that correspond to virtual endpoints on a remote device may be reconnected at any time to accommodate desired topologies of specific transport types. In such an aspect, UNIX based virtual endpoints may be considered local and as such may not be considered candidates for reconnection. Further, TCP-based virtual endpoints may be optimized for one hop routing (e.g., each bus node 712 and 732 may be directly connected to each other). Still further, Bluetooth-based virtual endpoints may be optimized for a single pico-net (e.g., one master and n slaves) in which the Bluetooth-based master may be the same bus node as a local master node.

In one embodiment, the bus node 712 and the bus node 732 may exchange bus state information at 762 to merge bus instances and enable communication over the distributed bus. For example, in one embodiment, the bus state information may include a mapping between a well-known name and a unique endpoint name, matching rules, routing group information, or other suitable information. In one embodiment, the state information may be communicated between the bus node 712 and the bus node 732 instances using an interface that local endpoints 714 and 734 may implement to communicate using a local name associated with the distributed bus. In another aspect, bus node 712 and bus node 732 may each may maintain a local bus controller responsible for providing feedback to the distributed bus, wherein the bus controller may translate global methods, arguments, signals, and other information into the standards associated with the distributed bus. At 764, the bus node 712 and the bus node 732 may communicate (e.g., broadcast) signals to inform the respective local endpoints 714 and 734 about any changes introduced during bus node connections, such as described above. In one embodiment, new and/or removed global and/or translated names may be indicated with name owner changed signals. Furthermore, global names that may be lost locally (e.g., due to name collisions) may be indicated with name lost signals. Still further, global names that are transferred due to name collisions may be indicated with name owner changed signals and unique names that disappear if and/or when the bus node 712 and the bus node 732 become disconnected may be indicated with name owner changed signals.

As used above, well-known names may be used to uniquely describe local endpoints 714 and 734. In one embodiment, when communications occur between Device A 710 and Device B 730, different well-known name types may be used. For example, a device local name may exist only on the bus node 712 associated with Device A 710 to which the bus node 712 directly attaches. In another example, a global name may exist on all known bus nodes 712 and 732, where only one owner of the name may exist on all bus segments. In other words, when the bus node 712 and bus node 732 are joined and any collisions occur, one of the owners may lose the global name. In still another example, a translated name may be used when a client is connected to other bus nodes associated with a virtual bus. In such an aspect, the translated name may include an appended end (e.g., a local endpoint 714 with well-known name “org.foo” connected to the distributed bus with Globally Unique Identifier “1234” may be seen as “G1234.org.foo”).

At 766, the bus node 712 and the bus node 732 may communicate (e.g., broadcast) signals to inform other bus nodes of changes to endpoint bus topologies. Thereafter, traffic from local endpoint 714 may move through virtual endpoints to reach intended local endpoint 734 on Device B 730. Further, in operation, communications between local endpoint 714 and local endpoint 734 may use routing groups. In one aspect, routing groups may enable endpoints to receive signals, method calls, or other suitable information from a subset of endpoints. As such, a routing name may be determined by an application connected to a bus node 712 or 732. For example, a P2P application may use a unique, well-known routing group name built into the application. Further, bus nodes 712 and 732 may support registering and/or de-registering of local endpoints 714 and 734 with routing groups. In one embodiment, routing groups may have no persistence beyond a current bus instance. In another aspect, applications may register for their preferred routing groups each time they connect to the distributed bus. Still further, groups may be open (e.g., any endpoint can join) or closed (e.g., only the creator of the group can modify the group). Yet further, a bus node 712 or 732 may send signals to notify other remote bus nodes or additions, removals, or other changes to routing group endpoints. In such embodiments, the bus node 712 or 732 may send a routing group change signal to other group members whenever a member is added and/or removed from the group. Further, the bus node 712 or 732 may send a routing group change signal to endpoints that disconnect from the distributed bus without first removing themselves from the routing group.

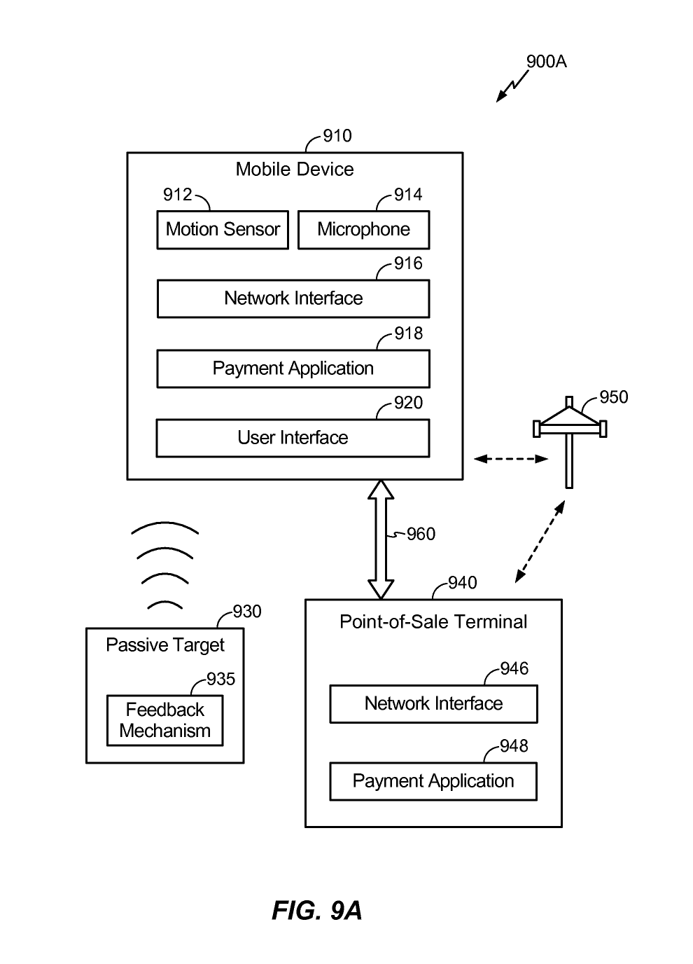

According to one aspect of the disclosure, FIG. 8A illustrates an exemplary proximity-based distributed bus that may be formed between a first host device 810 and a second host device 830. More particularly, as described above with respect to FIG. 6, the basic structure of the proximity-based distributed bus may comprise multiple bus segments that reside on physically separate host devices. Accordingly, each segment of the proximity-based distributed bus is generally located on a particular host device (e.g., host devices 810 and 830 in FIG. 8A) and a daemon or “bus router” implements the bus segment on each host device, which are shown FIG. 8A as the bubbles labeled “D.” Furthermore, there may be several bus attachments on a particular host device, where each bus attachment connects to the local daemon. For example, in FIG. 8A, the bus attachments on host devices 810 and 830 are illustrated as hexagons that each correspond to a service (S) or a client (C) that may request a service.

However, because embedded devices may lack sufficient resources to run a local daemon, FIG. 8B illustrates an exemplary proximity-based distributed bus in which one or more embedded devices 820, 825 can connect to a host device (e.g., host device 830) to connect to the proximity-based distributed bus. As such, the embedded devices 820, 825 may generally “borrow” a daemon running on another host device, whereby FIG. 8B shows an arrangement where the embedded devices 820, 825 are physically separate devices from the host device 830 running the borrowed daemon that manages the distributed bus segment on which the embedded devices 820, 825 reside. In general, the connection between the embedded devices 820, 825 and the host device 830 may be made according to the Transmission Control Protocol (TCP) and the network traffic flowing between the embedded devices 820, 825 and the host device 830 may comprise messages that implement bus methods, bus signals, and properties flowing over respective sessions in a similar manner to that described in further detail above with respect to FIGS. 6 and 7.

In general, the embedded devices 820, 825 may connect to the host device 830 according to a discovery and connection process that may be conceptually similar to the discovery and connection process between clients and services, wherein a host device may advertise a well-known name that signals an ability or willingness to host one or more embedded devices (e.g., “org.alljoyn.BusNode”). In one use case, an embedded device may simply connect to the “first” host device that advertises the well-known name. Alternatively, in other use cases, one or more embedded devices may adaptively connect to a particular host device and thereby join the proximity-based distributed bus according to properties associated with the host devices (e.g., type, load status, etc.) and/or requirements associated with the embedded devices (e.g., a ranking table that expresses a preference to connect to host devices from the same manufacturer).

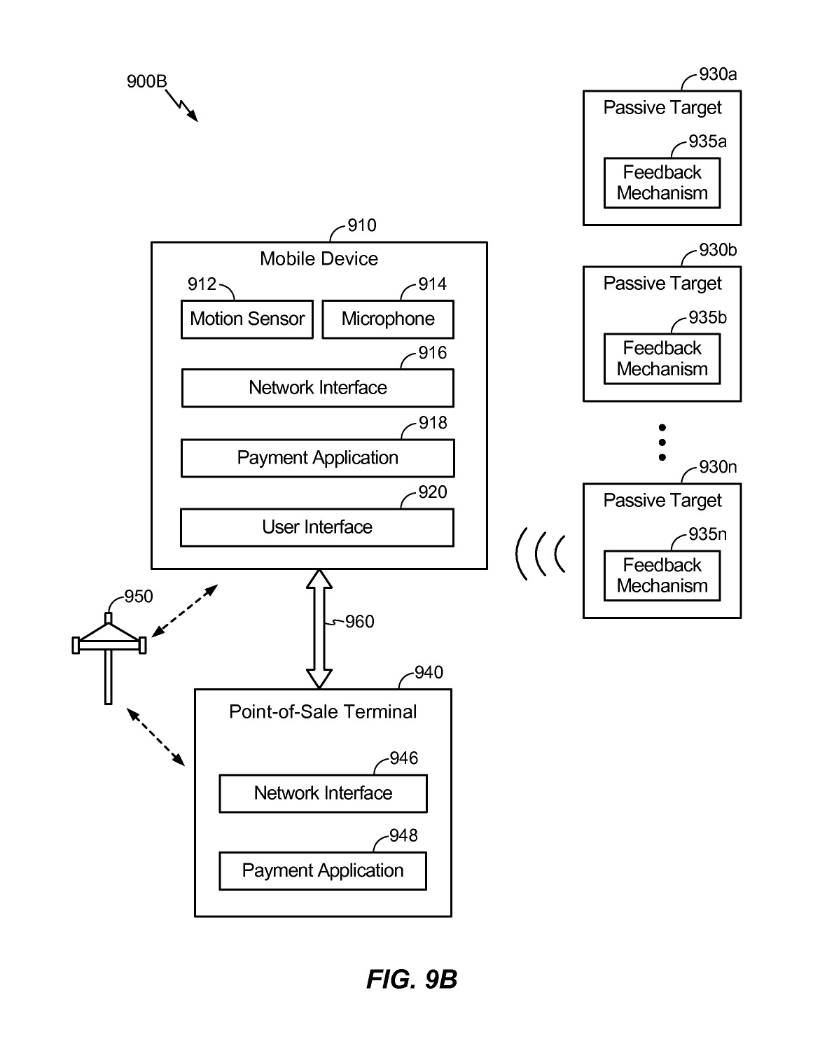

According to one aspect of the disclosure, FIG. 9A illustrates an exemplary environment 900A in which proximity-based P2P communication and an intent-to-pay gesture may be used to support mobile payments at a point-of-sale (POS). More particularly, the mobile payment environment 900A shown in FIG. 9A may generally combine a proximity-based P2P network technology that provides connectivity between a payment application 918 running on a mobile device 910 and a POS terminal 940 with an intent-to-pay indication based solely on input from existing sensors 912 in the mobile device 910. In general, the mobile device 910 and the POS terminal 940 may have respective network interfaces 916 and 946 that the mobile device 910 and the POS terminal 940 employ to communicate over Wi-Fi, Bluetooth, Wi-Fi Direct, or another suitable short-range wireless technology rather than NFC. In one embodiment, the proximity-based P2P network technology may include the AllJoyn™ software framework, which has been designed to enable interoperability among connected products and software applications from different manufacturers to dynamically create proximal networks and facilitate proximal P2P communication.

For example, in one embodiment, the mobile device 910 and the POS terminal 940 may each run respective bus daemons that communicate with one another over a distributed bus 960 formed between the mobile device 910 and the POS terminal 940 in an ad hoc based on proximal discovery. As such, the payment application 918 running on the mobile device 910 may directly communicate with the local bus daemon and a payment application 948 running on the POS terminal 940 may similarly communicate directly with the local bus daemon, wherein the local bus daemons on the mobile device 910 and the POS terminal 940 may manage namespaces and message routing to enable P2P communication over the distributed bus 960. In one embodiment, the local bus daemons on the mobile device 910 and the POS terminal 940 may generally form the distributed bus 940 and connect to one another in response to discovering that the other exists when the mobile device 910 and the POS terminal 940 are proximally located.

More specifically, in order to provide a mobile payment service, the payment application 948 running on the POS terminal 940 may reserve a particular name to the mobile payment service and advertise that the mobile payment service exists to any other devices that may be in proximity to the POS terminal 940, wherein the service advertisement may be communicated transparently via underlying technologies that may be implemented in the network interface 946. For example, the service advertisement may include a User Datagram Protocol (UDP) message or other suitable Internet Protocol (IP) message multicasted over a connected Wi-Fi access point 950, a pre-association service advertisement in Wi-Fi Direct that enables P2P connections without requiring a wireless access point 950, or a Bluetooth Service Discovery Protocol (SDP) message. The payment application 918 running on the mobile device 910 may initiate a discovery operation to declare interest in receiving service advertisements, whereby the local bus daemons on the POS terminal 940 and the mobile device 910 may respectively transmit and receive the advertisement that the mobile payment service exists once the mobile device 910 comes within a suitable proximity to the POS terminal 940. Accordingly, the local bus daemons on the POS terminal 940 and the mobile device 910 may then form the distributed bus 960 to enable proximity-based P2P communication between the payment application 918 running on the mobile device 910 and the payment application 948 running on the POS terminal 940. The payment application 918 running on the mobile device 910 and the payment application 948 running on the POS terminal 940 may then be conceptual peers that can communicate over the distributed bus 960 (e.g., using Remote Procedure Calls (RPC) to send and receive events over the respective local bus daemons, keep the P2P connection alive using session reference counting, etc.).

Accordingly, to use the distributed bus 960 (or another suitable proximity-based P2P communication mechanism) in order to facilitate mobile payments, the mobile device 910 may be equipped with a three-dimensional accelerometer, gyroscope, or other suitable motion sensor 912 that can detect movement associated with the mobile device 910 with a high degree of accuracy. As such, in one embodiment, the payment application 918 running on the mobile device 910 may be configured to unambiguously detect an intent-to-pay motion that the motion sensor 912 detects in response to a user making an intent-to-pay gesture with the mobile device 910 against a suitably constructed passive target 930 installed at the point-of-sale. For example, in one embodiment, the passive target 930 may display instructions or be printed with instructions such as “gesture device here to pay” and have a resilient construction to ensure the mobile device 910 will not be damaged when the user gestures the mobile device 910 against the passive target 930. Alternatively (or additionally), the passive target 930 may be printed with a quick response (QR) code or have other suitable physical features that can be recognized or otherwise detected using the mobile device 910. For example, in one embodiment, the payment application 918 may detect sufficient proximity to the passive target 930 (e.g., sufficient proximity to determine an intent-to-transact) in response to a camera on the mobile device 910 capturing the QR code printed on the passive target 930 and determining proximity based on a size that the captured QR code has in the camera frame. In another example, the intent-to-transact may be inferred based on the point-of-sale terminal 940 being the focal point of the camera (e.g., as determined using one or more recognizable features associated with the point-of-sale terminal 940), which may indicate proximity between the mobile device 910 and the point-of-sale terminal 940. In any case, the passive target 930 may generally not have communication capabilities and may not require any connectivity, in that the passive target 930 may instead be used to determine proximity that indicates intent-to-transact (e.g., customer presence near a cash register or other point-of-sale where the passive target 930 has been positioned).

In one embodiment, the payment application 918 running on the mobile device 910 may detect the distinctive motion indicating that the mobile device 910 contacted the passive target 930 and detect that the user has indicated an intent-to-transact. Alternatively (or additionally), the intent-to-pay gesture may be independent from the passive target 930, in that any suitable distinctive motion of the mobile device 910 that can be detected with the motion sensor 912 and used to capture intent-to-transact may be defined and used as the intent-to-pay gesture (e.g., by the payment application 918, by user customization, etc.). Accordingly, in response to the payment application 918 running on the mobile device 910 detecting the intent-to-pay gesture indicating the user intent-to-transact, the payment application 918 may then display transaction details and a confirmation button on a user interface 920. In either case, the transaction details may generally itemize one or more goods or services associated with the transaction, indicate costs associated with the itemized goods or services, identify the transaction (e.g., according to a user identifier, a device identifier, an order number, etc.). As such, the user may then review the transaction details displayed on the user interface 920 and press the confirmation button to approve the mobile payment, which may cause the payment application 918 to transmit a suitable message to the payment application 948 on the POS terminal 940 over the distributed bus 960 to complete the mobile payment. Alternatively, in response to the user selecting an option to not approve the mobile payment (e.g., because the transaction details are incorrect), the message transmitted from the payment application 918 on the mobile device 910 to the payment application 948 on the POS terminal 940 may terminate or otherwise discard the transaction. Furthermore, in one embodiment, the POS terminal 940 may be configured to send an alert to the mobile device 910 over the distributed bus 960 to inform the user that the transaction is ready to be conducted. For example, in an establishment where a customer places an order and pays when the order is ready, the alert sent to the mobile device 910 may inform the customer that the order is ready and the user may then make the intent-to-pay gesture in order to conduct the transaction (e.g., by making the intent-to-pay gesture against the passive target 930, making an intent-to-pay gesture that may be independent from the passive target 930, etc.).

In one embodiment, the passive target 930 may have physical characteristics that may further refine the intent-to-transact detection avoid false positives. For example, the passive target 930 may be designed to resonate or have another feedback mechanism 935 that can provide tactile feedback such that the bounce that results from making the intent-to-pay gesture against the passive target 930 results in a very specific motion that can be unambiguously detected. Furthermore, in one embodiment, the passive target 930 may be constructed as a molded plastic box having an inner void that provides a resonant cavity feedback mechanism 935. In this respect, a microphone 914 on the mobile device 910 may be temporarily activated (e.g., for a brief time period) after the payment application 918 detects the distinctive intent-to-pay gesture in order to detect resonance information that the resonant cavity feedback mechanism 935 produces when the mobile device 910 has been gestured against the passive target 930. Further still, the passive target 930 may be constructed to have a distinct resonant response that the payment application 918 can analyze to identify the passive target 930. For example, FIG. 9B illustrates another exemplary environment 900B in which proximity-based P2P communication and the intent-to-pay gesture may support mobile payments, wherein the environment 900B shown in FIG. 9B may be implemented at a point-of-sale (POS) where multiple passive targets 930a-930n having respective feedback mechanisms 935 that produce different resonant responses may be installed. As such, in one embodiment, the payment application 918 on the mobile device 910 can determine which of the passive targets 930a-930n the mobile device 910 was gestured against based on the resonant response that the microphone 914 detects. For example, in a fast-food store with four checkout lines, different passive targets 930a-930n in the various checkout lines may have respective feedback mechanisms 935a-935n that produce different resonance responses, which may allow the payment application 918 to report which checkout line the mobile payment was made from when communicating with the payment application 948 on the POS terminal 940 (e.g., passive target 930n in the example shown in FIG. 9B).

Accordingly, relative to NFC-based solutions, the mechanisms described above in which proximity-based P2P communication and a passive target 930 may support mobile payments may advantageously leverage infrastructure that already exists in many retails outlets and existing mobile devices 910 and leverage Wi-Fi, Bluetooth, Wi-Fi Direct, and other widespread wireless technologies that can easily support P2P communication. Furthermore, the passive target 930 may manufactured inexpensively and easily installed at the POS because the passive target 930 may not have any radios or other communication interfaces and therefore do not require any connectivity, and moreover, the distinctive intent-to-pay gesture used to make the mobile payments may be simple to explain and easily understood to consumers, possibly more so than the swipe-to-pay gesture used in NFC-based solutions because the passive target 930 may provide tactile and/or resonant feedback and the payment application 918 may provide visual feedback via the user interface 920.

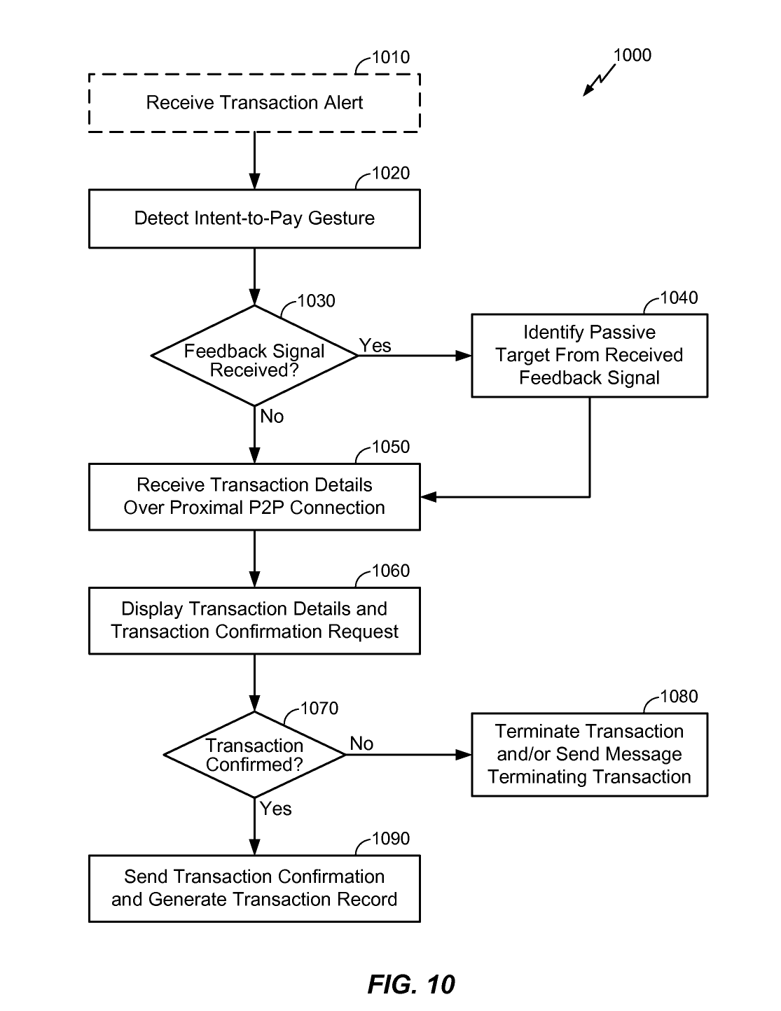

According to one aspect of the disclosure, FIG. 10 illustrates an exemplary method 1000 that a mobile device may perform to make mobile payments using proximity-based P2P communication and an intent-to-pay gesture. In particular, as noted above, the mobile device may have a three-dimensional accelerometer, gyroscope, or other suitable motion sensor that can detect movement associated with a high degree of accuracy, wherein a payment application running on the mobile device may detect a distinctive intent-to-pay motion at block 1020 based on one or more signals received from the motion sensor in response to a user making an intent-to-pay gesture with the mobile device against a suitably constructed passive target installed at a point-of-sale (POS). For example, the passive target may be designed to resonate or have another feedback mechanism that can provide tactile feedback such that the bounce that results from making the intent-to-pay gesture against the passive target results in a specific motion that can be unambiguously detected at block 1020. Furthermore, in one embodiment, the mobile device may optionally receive a transaction alert from the POS terminal at block 1010, wherein the transaction alert may inform the user that the transaction is ready to be conducted. For example, in an establishment where a customer places an order and pays when the order is ready, the alert received at block 1010 may inform the customer that the order is ready and the user may then make the intent-to-pay gesture in order to conduct the transaction at block 1020.

In one embodiment, the passive target may be constructed with or otherwise have a resonant feedback mechanism, wherein a microphone on the mobile device may be temporarily activated (e.g., for a brief time period) after the payment application detects the distinctive intent-to-pay gesture at block 1020 to detect a resonant feedback signal. As such, in response to the payment application running on the mobile device determining that the microphone picked up or otherwise received a resonant feedback signal at block 1030, the payment application may then analyze the feedback signal to identify the passive target at block 1040. For example, the passive target may be constructed to produce a specific resonant response the payment application can analyze to identify the passive target at block 1040.

In one embodiment, in response to making the distinctive intent-to-pay gesture against the passive target, the payment application on the mobile device may then request and receive details associated with the transaction over a proximal P2P connection at block 1050. For example, as described in further detail above, the POS terminal may advertise a mobile payment service to any other devices that may be in proximity thereto, and the proximal P2P connection between the mobile device and the POS terminal may be formed in response to the mobile device receiving the mobile payment service advertisement after coming within a suitable proximity to the POS terminal and initiating a P2P communication session to establish the proximal P2P connection with the POS terminal. In one embodiment, the payment application running on the mobile device may then display the transaction details and request that the user confirm the transaction details at block 1060. As such, in response to determining that the user confirmed or otherwise approved the transaction at block 1070, the payment application may then send a suitable message to confirm the transaction to the POS terminal over the proximal P2P connection in order to complete the mobile payment and generate a record associated with the transaction at block 1090. Alternatively, in response to determining that the user did not confirm the transaction at block 1070, the mobile device may terminate the transaction and/or transmit an appropriate message to terminate the transaction to the POS terminal over the proximal P2P connection at block 1080.

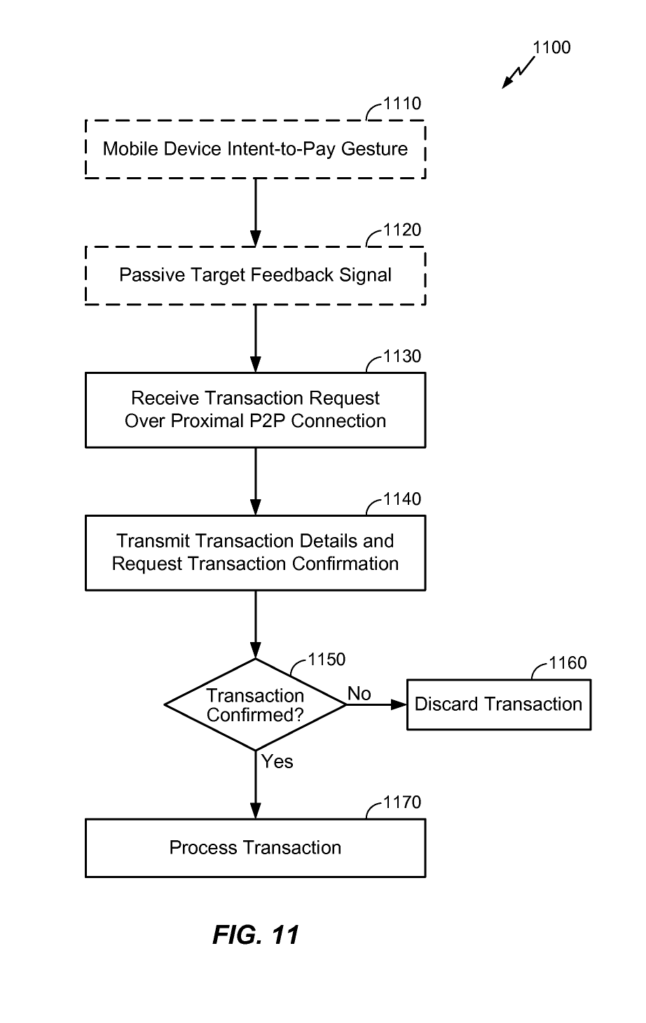

According to one aspect of the disclosure, FIG. 11 illustrates an exemplary method 1100 that the POS terminal device may perform to process mobile payments using proximity-based P2P communication and an intent-to-pay gesture. In particular, the method 1100 may generally be initiated in response to a payment application running on a mobile device detecting a distinctive intent-to-pay motion at block 1110 (e.g., based on one or more signals that a motion sensor on the mobile device generates in response to a user making the intent-to-pay gesture with the mobile device against a passive target that resonates or otherwise produces a suitable tactile feedback mechanism that the motion sensor can unambiguously detect). Furthermore, in one embodiment, the passive target may optionally have a resonant feedback mechanism designed that can produce a distinctive resonant response (e.g., a signal having a particular frequency) at block 1120, wherein the mobile device may analyze any resonant response that may be detected subsequent to the intent-to-pay motion to identify the passive target.

In one embodiment, in response to making the distinctive intent-to-pay motion with the mobile device, the POS terminal may then receive a request for transaction details from the mobile device over a proximal P2P connection at block 1130, wherein the POS terminal may then transmit the transaction details and a transaction confirmation request to the mobile device over the proximal P2P connection at block 1140. In one embodiment, in response to determining that a message received from the mobile device confirms the transaction at block 1150, the POS terminal may then process or otherwise complete the mobile payment at block 1170. Otherwise, in response to determining at block 1150 that the message received from the mobile device terminated or rejected the transaction, or alternatively that the mobile device did not provide a response to the transaction confirmation request, the POS terminal may terminate or otherwise discard the transaction at block 1160.

While the embodiments disclosed above have been described primarily with reference to P2P communication based on Wi-Fi, Bluetooth, Wi-Fi Direct, or other short-range wireless technologies using the AllJoyn™ software framework that enables proximity-based P2P communication, those skilled in the art will appreciate that the embodiments disclosed above can be implemented or otherwise directed to other suitable wireless network architectures and/or protocols. Furthermore, additional details that relate to the AllJoyn™ software framework that may provide the proximity-based P2P network technology used in the aspects and embodiments described herein are described and illustrated in the AllSeen Alliance document “Introduction to AllJoyn,” which is hereby expressly incorporated by reference and made part of this disclosure.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for making a mobile payment, comprising:
detecting, on a mobile device, an intent-to-pay gesture indicating that the mobile device was gestured against a passive target lacking a communication interface based on one or more signals generated with one or more sensors on the mobile device;
receiving transaction details at the mobile device over a proximal peer-to-peer connection in response to detecting the intent-to-pay gesture; and
sending a message over the proximal peer-to-peer connection to complete the mobile payment in response to an input confirming the transaction details.

2. The method recited in claim 1, wherein the passive target has a construction that causes the passive target to resonate when the intent-to-pay gesture is made against the passive target such that the one or more signals indicate the intent-to-pay gesture.

3. The method recited in claim 1, wherein the passive target has a resonant cavity that produces a distinct resonant response.

4. The method recited in claim 3, further comprising:
identifying the passive target against which the mobile device was gestured based on the distinct resonant response.

5. The method recited in claim 4, wherein identifying the passive target comprises:
temporarily activating a microphone on the mobile device to capture the distinct resonant response in response to detecting the intent-to-pay gesture.

6. The method recited in claim 1, wherein the intent-to-pay gesture comprises a distinctive motion that indicates intent-to-transact.

7. The method recited in claim 6, further comprising:
capturing information printed on the passive target using a camera on the mobile device; and
confirming the intent-to-transact in response to a size of the printed information within the camera frame indicating that the mobile device is within a predefined proximity to a point-of-sale.

8. The method recited in claim 6, further comprising:
determining a focal point associated with a camera on the mobile device; and
confirming the intent-to-transact in response to determining that the camera focal point corresponds to a point-of-sale located in proximity to the mobile device.

9. The method recited in claim 1, further comprising:
requesting the transaction details from a point-of-sale terminal over the proximal peer-to-peer connection in response to detecting the intent-to-pay gesture; and
displaying the transaction details and a transaction confirmation request on the mobile device in response to receiving the transaction details, wherein the transaction details indicate one or more of itemized goods or services associated with the mobile payment, costs associated with the itemized goods or services, or information to identify the transaction.

10. A mobile device, comprising:
one or more sensors configured to generate one or more signals indicating that the mobile device was gestured against a passive target lacking a communication interface;
one or more processors configured to detect an intent-to-pay gesture based on the one or more signals that the one or more sensors generated; and
a network interface configured to receive transaction details over a proximal peer-to-peer connection in response to the intent-to-pay gesture and to send a message over the proximal peer-to-peer connection to complete a mobile payment in response to an input confirming the transaction details.

11. The mobile device recited in claim 10, wherein the passive target has a construction that causes the passive target to resonate when the intent-to-pay gesture is made against the passive target such that the one or more signals indicate the intent-to-pay gesture.

12. The mobile device recited in claim 10, wherein the passive target has a resonant cavity that produces a distinct resonant response.

13. The mobile device recited in claim 12, wherein the one or more processors are further configured to identify the passive target against which the mobile device was gestured based on the distinct resonant response.

14. The mobile device recited in claim 13, further comprising:
a microphone configured to capture the distinct resonant response, wherein the one or more processors are further configured to temporarily activate the microphone in response to detecting the intent-to-pay gesture.

15. The mobile device recited in claim 10, wherein the intent-to-pay gesture comprises a distinctive motion that indicates intent-to-transact.

16. The mobile device recited in claim 15, further comprising:
a camera configured to capture information printed on the passive target, wherein the one or more processors are further configured to confirm the intent-to-transact in response to the printed information having a size within the camera frame that indicates a predefined proximity between the mobile device and a point-of-sale.

17. The mobile device recited in claim 15, further comprising:
a camera having a focal point, wherein the one or more processors are further configured to determine the focal point associated with the camera and confirm the intent-to-transact in response to the camera focal point corresponding to a point-of-sale located in proximity to the mobile device.

18. The mobile device recited in claim 10, further comprising:
a user interface configured to display the transaction details and a transaction confirmation request in response to the network interface receiving the transaction details, wherein the transaction details indicate one or more of itemized goods or services associated with the mobile payment, costs associated with the itemized goods or services, or information to identify the transaction.

19. An apparatus, comprising:
means for detecting an intent-to-pay gesture indicating that the apparatus was gestured against a passive target lacking a communication interface;
means for receiving transaction details over a proximal peer-to-peer connection in response to the intent-to-pay gesture; and
means for sending a message over the proximal peer-to-peer connection to complete a mobile payment in response to an input confirming the transaction details.

20. The apparatus recited in claim 19, further comprising:
means for capturing a distinct resonant response produced by the passive target; and
means for identifying the passive target against which the apparatus was gestured based on the captured distinct resonant response.

21. The apparatus recited in claim 19, further comprising:
means for capturing information printed on the passive target; and
means for confirming that the intent-to-pay gesture indicates an intent-to-transact in response to the captured printed information indicating a predefined proximity to a point-of-sale.

22. The apparatus recited in claim 19, further comprising:
means for determining whether the intent-to-pay gesture indicates an intent-to-transact based on a proximity to a point-of-sale.

23. The apparatus recited in claim 19, further comprising:
means for requesting the transaction details from a point-of-sale terminal over the proximal peer-to-peer connection in response to detecting the intent-to-pay gesture; and
means for displaying the transaction details and a transaction confirmation request in response to receiving the transaction details, wherein the transaction details indicate one or more of itemized goods or services associated with the mobile payment, costs associated with the itemized goods or services, or information to identify the transaction.

24. A computer-readable storage medium having computer-executable instructions recorded thereon, wherein executing the computer-executable instructions on a mobile device causes the mobile device to:
detect an intent-to-pay gesture indicating that the mobile device was gestured against a passive target lacking a communication interface based on one or more signals generated with one or more sensors on the mobile device;
receive transaction details at the mobile device over a proximal peer-to-peer connection in response to detecting the intent-to-pay gesture; and
send a message over the proximal peer-to-peer connection to complete a mobile payment in response to an input confirming the transaction details.

25. A method for making a mobile payment, comprising:
detecting, on a mobile device, an intent-to-transact based on information captured using a camera on the mobile device;
receiving transaction details at the mobile device over a proximal peer-to-peer connection in response to detecting the intent-to-transact; and
sending a message over the proximal peer-to-peer connection to complete the mobile payment in response to an input confirming the transaction details.

26. The method recited in claim 25, wherein detecting the intent-to-transact comprises:
capturing printed information located at a point-of-sale using the camera; and
detecting the intent-to-transact based on the printed information having a size within the camera frame indicating that the mobile device is located within a predefined proximity to the point-of-sale.

27. The method recited in claim 25, wherein detecting the intent-to-transact comprises:
determining a focal point associated with the camera; and
detecting the intent-to-transact in response to determining that the camera focal point corresponds to a point-of-sale.

28. A mobile device, comprising:
a camera;
one or more processors configured to detect an intent-to-transact based on information captured using the camera; and
a network interface configured to receive transaction details over a proximal peer-to-peer connection in response to the one or more processors detecting the intent-to-transact and to send a message over the proximal peer-to-peer connection to complete a mobile payment in response to an input confirming the transaction details.

29. The mobile device recited in claim 28, wherein the camera is configured to capture printed information located at a point-of-sale, and wherein the one or more processors are further configured to detect the intent-to-transact based on the printed information having a size within the camera frame indicating a predefined proximity to the point-of-sale.

30. The mobile device recited in claim 28, wherein the one or more processors are further configured to determine a focal point associated with the camera and detect the intent-to-transact in response to determining that the camera focal point corresponds to a point-of-sale.

31. An apparatus, comprising:
means for detecting an intent-to-transact based on information captured using a camera;
means for receiving transaction details over a proximal peer-to-peer connection in response to detecting the intent-to-transact; and
means for sending a message over the proximal peer-to-peer connection to complete a mobile payment in response to an input confirming the transaction details.

32. The apparatus recited in claim 31, wherein the information captured using the camera comprises printed information located at a point-of-sale, and wherein the means for detecting the intent-to-transact is configured to detect the intent-to-transact based on the printed information having a size within the camera frame indicating a predefined proximity to the point-of-sale.

33. The apparatus recited in claim 31, wherein the information captured using the camera comprises a focal point associated with the camera and wherein the means for detecting the intent-to-transact is configured to detect the intent-to-transact in response to determining that the camera focal point corresponds to a point-of-sale.

34. A computer-readable storage medium having computer-executable instructions recorded thereon, wherein executing the computer-executable instructions on a mobile device causes the mobile device to:
detect an intent-to-transact based on information captured using a camera;
receive transaction details over a proximal peer-to-peer connection in response to detecting the intent-to-transact; and
send a message over the proximal peer-to-peer connection to complete a mobile payment in response to an input confirming the transaction details.
